(19) United States
(12) Patent Application Publication
(10) Pub. No.: US 2026/0229177 A1
(43) Pub. Date: Aug. 6, 2026

(54) DISPLAY DEVICE AND ELECTRONIC DEVICE HAVING THE SAME

(71) Applicant: Samsung Display Co., Ltd., Yongin-si (KR)

(72) Inventors: Byung Chang YU, Yongin-si (KR); Kyung Ho KIM, Yongin-si (KR); Jung Hwan HWANG, Yongin-si (KR)

(21) Appl. No.: 19/377,477

(22) Filed: Nov. 3, 2025

(30) Foreign Application Priority Data
Jan. 31, 2025 (KR) 10-2025-0012679

(51) Int. Cl. G09G 3/3233; G09G 3/3266

(52) U.S. Cl. CPC G09G 3/3233; G09G 3/3266; G09G 2300/0426; G09G 2300/0452; G09G 2300/0819; G09G 2300/0852; G09G 2300/0861; G09G 2310/0286; G09G 2310/08; G09G 2330/021

(57) ABSTRACT

A display device includes: a plurality of sub-pixel circuits arranged in a matrix form having a plurality of rows and a plurality of columns; a plurality of light emitting devices, each of the plurality of light emitting devices being connected to a corresponding sub-pixel circuit from among the plurality of sub-pixel circuits; a data driver configured to output a data signal to the plurality of sub-pixel circuits through a plurality of output lines; and a scan driver configured to output a scan signal to the plurality of sub-pixel circuits through a plurality of first scan lines, a plurality of second scan lines, and a plurality of third scan lines, wherein each of the plurality of output lines is connected in common to three sub-pixel circuits included in one pixel from among the plurality of sub-pixel circuits.

### CROSS-REFERENCE TO RELATED APPLICATION

The present application claims priority to and the benefit of Korean Patent Application Number 10-2025-0012679, filed on January 31, 2025, in the Korean Intellectual Property Office, the entire disclosure of which is incorporated by reference herein.

### BACKGROUND

### 1. Field

Various embodiments of the present disclosure relate to a display device and an electronic device having the same.

### 2. Description of Related Art

With the development of information technology, the importance of a display device, which is a connection medium between a user and information, has been emphasized. Owing to the importance of display devices, the use of various kinds of display devices, such as a liquid crystal display device, an organic light-emitting display device, and a plasma display device, has increased.

In general, a display device includes a display portion for displaying an image and a display driver for driving the display portion. The display portion includes a scan driver and a plurality of sub-pixels. The display driver includes a data driver which outputs a data signal to data lines and a timing controller. The timing controller controls the scan driver and the data driver.

The display device as described above may display an image by outputting a scan signal to a scan line connected to a pixel to be displayed and providing a data voltage corresponding to a display image to a data line connected to the pixel.

### SUMMARY

Aspects and features of embodiments of the present disclosure are to provide a display device capable of reducing power consumption required for an operation of a data driver and heat generation and reducing the number of transistors included in a display driver, and an electronic device having the same.

A display device according to one or more embodiments of the present disclosure includes a plurality of sub-pixel circuits, a plurality of light emitting devices, a data driver, and a scan driver. The plurality of sub-pixel circuits are arranged in a matrix form having a plurality of rows and a plurality of columns. Each of the plurality of light emitting devices is connected to a corresponding sub-pixel circuit from among the plurality of sub-pixel circuits. The data driver configured to output a data signal to the plurality of sub-pixel circuits through a plurality of output lines. The scan driver configured to output a scan signal to the plurality of sub-pixel circuits through a plurality of first scan lines, a plurality of second scan lines, and a plurality of third scan lines. Each of the plurality of output lines is connected in common to three sub-pixel circuits included in one pixel from among the plurality of sub-pixel circuits. Each of the plurality of first scan lines is connected to first color sub-pixel circuits in a corresponding row from among the plurality of sub-pixel circuits. Each of the plurality of second scan lines is connected to second color sub-pixel circuits in a corresponding row from among the plurality of sub-pixel circuits. Each of the plurality of third scan lines is connected to third color sub-pixel circuits in a corresponding row from among the plurality of sub-pixel circuits.

According to one or more embodiments, the plurality of sub-pixel circuits may be arranged in a matrix form having m rows and n columns. The number of the first scan lines may be m, the number of the second scan lines may be m, and the number of the output lines may be n/3. During a horizontal period corresponding to a selected row from among the plurality of rows, the scan driver may activate a voltage of a first scan line corresponding to the selected row from among the plurality of first scan lines during a first period of the horizontal period, may activate a voltage of a second scan line corresponding to the selected row from among the plurality of second scan lines during a second period of the horizontal period different from the first period, and may activate a voltage of a third scan line corresponding to the selected row from among the plurality of third scan lines during a third period of the horizontal period different from the first period and the second period. Here, m and n each are an integer of 2 or more.

According to one or more embodiments, during the first period, data output to the plurality of output lines may be applied to the first color sub-pixel circuits from among sub-pixel circuits corresponding to the selected row, during the second period, the data output to the plurality of output lines may be applied to the second color sub-pixel circuits from among the sub-pixel circuits corresponding to the selected row, and during the third period, the data output to the plurality of output lines may be applied to the third color sub-pixel circuits from among the sub-pixel circuits corresponding to the selected row.

According to one or more embodiments, the plurality of light emitting devices may be located above or below the plurality of sub-pixel circuits.

According to one or more embodiments, the three sub-pixel circuits may be arranged in a row direction in the one pixel.

According to one or more embodiments, a shared area may be located between sub-pixels in a first row and sub-pixels in a second row, and at least one common line, which is connected in common to the sub-pixels in the first row and the sub-pixels in the second row, may be in the shared area.

According to one or more embodiments, a circuit layout of each of the sub-pixels in the first row and a circuit layout of each of the sub-pixels in the second row may have linearly symmetrical shapes with respect to the shared area.

According to one or more embodiments, the common line may include a repair line for repairing a defective pixel.

According to one or more embodiments, the three sub-pixel circuits may be arranged in a column direction in the one pixel. A shared area may be located between sub-pixels in first to third rows and sub-pixels in fourth to sixth rows, and at least one common line, which is connected in common to the sub-pixels in the first to third rows and the sub-pixels in the fourth to sixth rows, may be in the shared area.

According to one or more embodiments, the third color sub-pixel circuits may be in the third and fourth rows nearest to the shared area in the one pixel, the second color sub-pixel circuits may be in the second and fifth rows adjacent to the third color sub-pixel circuits, and the first color sub-pixel circuits may be in the first and sixth rows farthest from the shared area in the one pixel.

According to one or more embodiments, a circuit layout of each of the sub-pixels in the first row and a circuit layout of each of the sub-pixels in the sixth row may have linearly symmetrical shapes with respect to the shared area, a circuit layout of each of the sub-pixels in the second row and a circuit layout of each of the sub-pixels in the fifth row may have linearly symmetrical shapes with respect to the shared area, and a circuit layout of each of the sub-pixels in the third row and a circuit layout of each of the sub-pixels in the fourth row may have linearly symmetrical shapes with respect to the shared area.

According to one or more embodiments, the data driver may be configured to output data to k output lines, the scan driver may be configured to output a scan signal to m first scan lines, m second scan lines, and m third scan lines. The plurality of sub-pixel circuits may be arranged in a matrix form having m rows and 3k columns. An h-th output line from among the output lines may be connected in common to sub-pixel circuits located in a (3h-2)-th column, a (3h-1)-th column, and a 3h-th column from among the plurality of sub-pixel circuits. An i-th first scan line from among the first scan lines may be connected to (3j-2)-th sub-pixel circuits from among the sub-pixel circuits located in an i-th row. An i-th second scan line from among the second scan lines may be connected to (3j-1)-th sub-pixel circuits from among the sub-pixel circuits located in the i-th row. An i-th third scan line from among the third scan lines may be connected to 3j-th sub-pixel circuits from among the sub-pixel circuits located in the i-th row. Here, m and n each are an integer of 2 or more, k is an integer of 1 or more, h is an integer greater than 0 and less than or equal to k, i is an integer greater than 0 and less than or equal to m, and j is an integer greater than 0 and less than or equal to k.

According to one or more embodiments, during a horizontal period corresponding to the i-th row, the scan driver may activate a voltage of the i-th first scan line during a first period of the horizontal period, may activate a voltage of the i-th second scan line during a second period of the horizontal period different from the first period, and may activate a voltage of the i-th third scan line during a third period of the horizontal period different from the first period and the second period.

According to one or more embodiments, a shared area may be located between sub-pixels in a (2i-1)-th row and sub-pixels in a 2i-th row, and at least one common line, which is connected in common to the sub-pixels in the (2i-1)-th row and the sub-pixels in the 2i-th row, may be arranged in the shared area.

A display device according to one or more embodiments of the present disclosure includes a data driver, a scan driver, and a pixel portion. The data driver may be configured to output data to k output lines. The scan driver may be configured to output a scan signal to m first scan lines, m second scan lines, and m third scan lines. The pixel portion is connected to the output lines, the first scan lines, the second scan lines, and the third scan lines. The pixel portion includes a plurality of sub-pixel circuits arranged in a matrix form having 3m rows and k columns, and a plurality of light emitting devices, each of the plurality of light emitting devices being connected to a corresponding sub-pixel circuit from among the plurality of sub-pixel circuits. An h-th output line from among the output lines is connected in common to sub-pixel circuits located in an h-th column from among the plurality of sub-pixel circuits. An i-th first scan line from among the first scan lines is connected to sub-pixel circuits in a (3i-2)-th row. An i-th second scan line from among the second scan lines is connected to sub- pixel circuits in a (3i-1)-th row. An i-th third scan line from among the third scan lines is connected to sub-pixel circuits in a 3i-th row. Here, m and n each are an integer of 2 or more, k is an integer of 1 or more, h is an integer greater than 0 and less than or equal to k, and i is an integer greater than 0 and less than or equal to m.

According to one or more embodiments, the sub-pixel circuits in the (3i-2)-th row may be first color sub-pixel circuits, the sub-pixel circuits in the (3i-1)-th row may be second color sub-pixel circuits, and the sub-pixel circuits in the 3i-th row may be third color sub-pixel circuits.

According to one or more embodiments, a shared area may be located between sub-pixels in the 3i-th row and sub-pixels in a (3i+1)-th row. At least one common line, which is connected in common to the sub-pixel circuits in the (3i-2)-th row, the sub-pixel circuits in the (3i-1)-th row, the sub-pixel circuits in the 3i-th row, sub-pixel circuits in the (3i+1)-th row, sub-pixel circuits in a (3i+2)-th row, and sub-pixel circuits in a (3i+3)-th row, may be located in the shared area.

According to one or more embodiments, the sub-pixel circuits in the (3i+1)-th row may be the third color sub-pixel circuits, the sub-pixel circuits in the (3i+2)-th row may be the second color sub-pixel circuits, and the sub-pixel circuits in the (3i+3)-th row may be the first color sub-pixel circuits.

According to one or more embodiments, a circuit layout of each of the sub-pixel circuits in the (3i+1)-th row and a circuit layout of each of the sub-pixel circuits in the 3i-th row may have linearly symmetrical shapes with respect to the shared area, a circuit layout of each of the sub-pixel circuits in the (3i+2)-th row and a circuit layout of each of the sub-pixel circuits in the (3i-1)-th row may have linearly symmetrical shapes with respect to the shared area, and a circuit layout of each of the sub-pixel circuits in the (3i+3)-th row and a circuit layout of each of the sub-pixel circuits in the (3i-2)-th row may have linearly symmetrical shapes with respect to the shared area.

An electronic device according to one or more embodiments of the present disclosure includes a processor and a display device. The processor may be configured to provide input image data. The display device may be configured to display an image based on the input image data. The display device includes a plurality of sub-pixel circuits, a plurality of light emitting devices, a data driver, and a scan driver. The plurality of sub-pixel circuits are arranged in a matrix form having a plurality of rows and a plurality of columns. Each of the plurality of light emitting devices is connected to a corresponding sub-pixel circuit from among the plurality of sub-pixel circuits. The data driver may be configured to output a data signal to the plurality of sub-pixel circuits through a plurality of output lines. The scan driver may be configured to output a scan signal to the plurality of sub-pixel circuits through a plurality of first scan lines, a plurality of second scan lines, and a plurality of third scan lines. Each of the plurality of output lines is connected in common to three sub-pixel circuits included in one pixel from among the plurality of sub-pixel circuits. Each of the plurality of first scan lines is connected to first color sub-pixel circuits in a corresponding row from among the plurality of sub-pixel circuits. Each of the plurality of second scan lines is connected to second color sub-pixel circuits in a corresponding row from among the plurality of sub-pixel circuits. Each of the plurality of third scan lines is connected to third color sub-pixel circuits in a corresponding row from among the plurality of sub-pixel circuits.

### BRIEF DESCRIPTION OF THE DRAWINGS

FIG. 1 is a diagram illustrating a display device according to one or more embodiments of the present disclosure.

FIG. 2 is a diagram illustrating a sub-pixel of FIG. 1.

FIG. 3 is a schematic diagram of an equivalent circuit of the sub-pixel of FIG. 1.

FIG. 4 is a diagram illustrating an embodiment of a pixel portion illustrated in FIG. 1.

FIG. 5 is a diagram illustrating data lines and scan lines connected to sub-pixel circuits shown in FIG. 4.

FIG. 6 is a timing diagram illustrating an operation of a display device according to one or more embodiments of the present disclosure.

FIG. 7 is a diagram illustrating a display device according to one or more embodiments of the present disclosure.

FIG. 8 is a diagram illustrating an embodiment of a pixel portion illustrated in FIG. 7.

FIG. 9 is a timing diagram illustrating an operation of a display device according to the embodiment of FIG. 8.

FIG. 10 is a diagram illustrating another embodiment of the pixel portion illustrated in FIG. 7.

FIG. 11 is a diagram illustrating another embodiment of the pixel portion illustrated in FIG. 7.

FIGS. 12A and 12B are diagrams illustrating embodiments of pixels sharing common lines arranged in a shared area.

FIG. 13 is a block diagram of an electronic device according to one or more embodiments.

FIG. 14 shows schematic diagrams of electronic devices according to various embodiments.

### DETAILED DESCRIPTION

Hereinafter, embodiments of the present disclosure will be described in detail with reference to the attached drawings, such that those skilled in the art may easily implement the present disclosure. The present disclosure may be implemented in various forms, and is not limited to the embodiments to be described herein below.

In the drawings, portions which are not related to the present disclosure will be omitted in order to explain the present disclosure more clearly. Reference should be made to the drawings, in which similar reference numerals are used throughout the different drawings to designate similar components. Therefore, the aforementioned reference numerals may be used in other drawings.

For reference, the size of each component and the thickness of each component are arbitrarily represented for the sake of explanation, and the present disclosure is not limited to what is illustrated in the drawings. In the drawings, the thickness of each component may be exaggerated to clearly depict multiple layers and areas.

Furthermore, the expression “being the same” may mean “being substantially the same”. In other words, the expression “being the same” may include a range that may be tolerated by those skilled in the art. The other expressions may also be expressions from which “substantially” has been omitted.

In this specification, it will be understood that when an element (or a region, a layer, a portion, or the like) is referred to as being "on", "connected to" or "coupled to" another element, it may be directly disposed on, connected to, or coupled to the other element, or other elements may be disposed therebetween.

In this application, the wording “directly disposed on” may indicate that a layer, a film, a region, a plate, etc., are not added between one part such as a layer, a film, a region, a plate, etc., and another part. For example, the wording “directly disposed on” may indicate that two layers or two members are disposed without using an additional member such as an adhesive member therebetween.

As used herein, the term "and/or" includes any and all combinations of one or more of the associated listed elements.

It will be understood that, although the terms “first”, “second”, etc. may be used herein to describe various elements, the elements are not to be limited by these terms. These terms are only used to distinguish one element from another element. For instance, a first element discussed below could be termed a second element without departing from the spirit or scope of the present disclosure. Similarly, a second element could be termed a first element. In this specification, the singular expressions “a”, “an” and “the” are intended to include the plural forms as well, unless the context clearly indicates otherwise.

In addition, the terms "below", “under”, "on the lower side", "above", “over”, "on the upper side", and/or the like may be used to describe the relationships between the elements illustrated in the drawings. These terms are relative concepts and are described on the basis of the directions indicated in the drawings.

It will be further understood that the terms "comprises, includes, has" and/or "comprising, including, having", when used in this specification, specify the presence of stated features, numbers, steps, operations, elements, components or combinations thereof, but do not preclude the possibility of the presence or addition of one or more other features, numbers, steps, operations, elements, components, and/or combinations thereof.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the present specification, the expression "A and/or B" indicates A, B, or A and B. In addition, the expression such as "at least one of A and B" may include A, B, or A and B.

In the present specification, the x-axis, the y-axis, and the z-axis are not limited to directions according to three axes of the rectangular coordinate system, and may be interpreted in a broader sense. For example, the x-axis, the y-axis, and the z-axis may be orthogonal to each other, but may refer to different directions that are not orthogonal to each other.

In the present specification, the term "plane" refers to when a target portion is viewed from above (e.g., when viewed in a direction perpendicular to the upper surface of a substrate), and the term "cross-sectional" refers to when a vertically cut cross-section of the target portion is viewed from the side.

In the present specification, when a first element overlaps a second element, it may mean that the first element is arranged over or below the second element and at least partially overlaps the second element in a plane.

In the present specification, when a certain embodiment may be implemented differently, a specific process order may also be performed differently from the described order. As an example, two processes that are successively described may be performed substantially concurrently (e.g., simultaneously) or performed in an order opposite to the order described.

Sizes of elements in the drawings may be exaggerated for convenience of description. For example, because sizes and thicknesses of elements in the drawings are arbitrarily illustrated for convenience of explanation, the following embodiments are not limited thereto.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

Hereinafter, embodiments of the present disclosure are described with reference to the drawings.

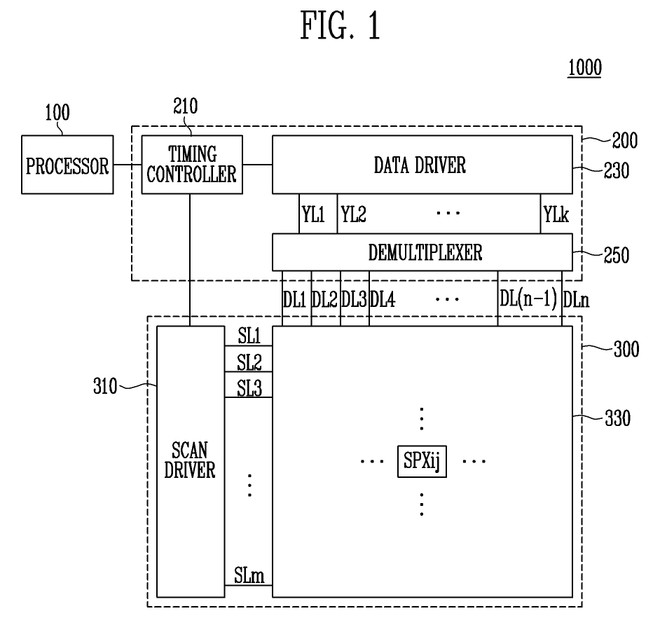

FIG. 1 is a diagram illustrating a display device 1000 according to one or more embodiments of the present disclosure.

Referring to FIG. 1, the display device 1000 according to one or more embodiments of the present disclosure includes a processor 100, a display driver 200, and a display portion 300. The display driver 200 may include a timing controller 210, a data driver 230, and a demultiplexer 250. In addition, the display portion 300 may include a scan driver 310 and a pixel portion 330.

The timing controller 210 may receive gradations and timing signals for each frame period from the processor 100. The processor may be at least one of a Graphics Processing Unit (GPU), a Central Processing Unit (CPU), an Application Processor (AP), and/or the like. The timing signals may include a vertical synchronization signal, a horizontal synchronization signal, a data enable signal, and/or the like.

Each cycle of the vertical synchronization signal may correspond to each frame period. Each cycle of the horizontal synchronization signal may correspond to each horizontal period. The gradations may be supplied on a horizontal line basis in each horizontal period in response to a pulse at an enable level of a data enable signal. A horizontal line may mean pixels (e.g., pixel rows) connected to the same scan line and the same emission line.

The timing controller 210 may render the gradations to correspond to specifications of the display device 1000. For example, the processor 100 may provide a red gradation, a green gradation, and a blue gradation for each unit dot. For example, when the pixel portion 330 has an RGB stripe structure, pixels may correspond to respective gradations in a one-to-one manner. In this case, rendering of gradations may be unnecessary. However, for example, when the pixel portion 330 has a PENTILE^{®} structure, because pixels are shared among adjacent unit dots, pixels might not correspond to respective gradations in a one-to-one manner. This PENTILE^{®} arrangement structure may be referred to as an RGBG matrix structure (e.g., a PENTILE^{®} matrix structure or an RGBG structure (e.g., a PENTILE^{®} structure)). PENTILE® is a registered trademark of Samsung Display Co., Ltd., Republic of Korea. In this case, rendering of gradations may be necessary. Rendered or unrendered gradations may be provided to the data driver 230. In addition, the timing controller 210 may provide a data control signal to the data driver 230. In addition, the timing controller 210 may provide a scan control signal to the scan driver 310.

The data driver 230 may generate data voltages (i.e., data signals) output to output lines YL1, YL2, …, and YLk using the gradations and the data control signal received from the timing controller 210. Here, k may be an integer greater than zero. The data signals output to the output lines YL1, YL2, …, and YLk may be multiplexed data signals. For example, a data signal output from the first output line YL1 may be selectively provided to a first data line DL1, a second data line DL2, or a third data line DL3. In addition, a data signal output from the second output line YL2 may be selectively provided to a fourth data line DL4, a fifth data line DL5, or a sixth data line DL6. In the above-described manner, a data signal output from the k-th output line YLk may be selectively provided to an (n-2)-th data line DL(n-2), an (n-1)-th data line DL(n-1) or an n-th data line DLn.

The demultiplexer 250 may demultiplex the data voltages output from the output lines YL1, YL2, … and YLk and selectively provide the demultiplexed data voltages to the data lines DL1, DL2, DL3, DL4 …, and DLn. In one or more embodiments, the demultiplexer 250 may be a 1:3 demultiplexer. In this case, n, which is the number of data lines DL1, DL2, DL3, DL4, …, and DLn, may be three times k, the number of output lines YL1, YL2, …, and YLk. In other words, a relationship of “n=3k” may be established.

The scan driver 310 may use the scan control signal (e.g., a clock signal, a scan start signal, and/or the like) received from the timing controller 210 to generate scan signals to be provided to scan lines SL1, SL2, …, and SLm. The scan driver 310 may sequentially supply scan signals having a turn-on level pulse to the scan lines SL1 to SLm. The scan driver 310 may include scan stages configured in the form of shift registers. The scan driver 310 may generate scan signals in a manner of sequentially transmitting a scan start signal in the form of a turn-on level pulse to a next scan stage under the control of a clock signal. Here, m may be an integer greater than zero.

In one or more embodiments, the scan driver 310 may be connected to a line in a row direction other than the scan lines SL1, SL2, …., and SLm.

The pixel portion 330 includes a plurality of sub-pixels SPXij. Each of the plurality of sub-pixels SPXij may be composed of a sub-pixel circuit and a light emitting device. Specifically, the pixel portion 330 may include sub-pixel circuits arranged in a matrix having m rows and n columns, and each of the sub-pixel circuits may be connected to an anode of a corresponding light emitting device. m and n may each be an integer greater than or equal to 2.

Each sub-pixel SPXij may be connected to a corresponding data line, and a corresponding scan line. The sub-pixel SPXij may be connected to the i-th scan line SLi and the j-th data line DLj. The sub-pixels may include sub-pixels emitting light of a first color, sub-pixels emitting light of a second color, and sub-pixels emitting light of a third color. The first color, the second color, and the third color may be different colors. For example, the first color may be one of red, green, or blue, the second color may be one of red, green, or blue, which is not the first color, and the third color may be the other color of red, green, or blue, which is not the first color and the second color. In addition, magenta, cyan, and yellow may be used instead of red, green, and blue as the first to third colors.

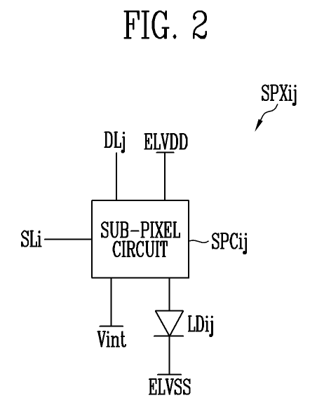

FIG. 2 is a diagram illustrating the sub-pixel SPXij of FIG. 1.

Referring to FIG. 2, the sub-pixel SPXij includes a sub-pixel circuit SPCij and a light emitting device LDij.

The sub-pixel circuit SPCij may include a plurality of transistors. In one or more embodiments, the sub-pixel circuit SPCij may include a driving transistor. Depending on a gate voltage of the driving transistor, a current applied to the light emitting device LDij may be controlled.

In one or more embodiments, the sub-pixel circuit SPCij may include one or more capacitors. Because the sub-pixel circuit SPCij may be implemented in various manners, detailed descriptions of implementation examples of the sub-pixel circuit SPCij will be omitted herein.

The scan line SLi and the data line DLj may be connected to the sub-pixel circuit SPCij. In addition, the sub-pixel circuit SPCij may be connected to a first power line ELVDD, an initialization voltage line Vint, and a second power line ELVSS.

The light emitting device LDij may have an anode connected to the sub-pixel circuit SPCij and a cathode connected to the second power line ELVSS. The light emitting device LDij may be a light emitting diode. The light emitting device LDij may be composed of an organic light emitting diode (OLED), an inorganic light emitting diode, a quantum dot/well light emitting diode, and/or the like. The light emitting device LDij may emit light in one of the first color, the second color, or the third color. In this embodiment, only one light emitting device LDij is provided in each pixel, but in other embodiments, a plurality of light emitting devices may be provided in each pixel. The plurality of light emitting devices may be connected in series, in parallel, in series-parallel, and/or the like.

A first power voltage may be applied to the first power line ELVDD, a second power voltage may be applied to the second power line ELVSS, and an initialization voltage may be applied to the initialization voltage line Vint. For example, the first power voltage may be greater than the second power voltage. For example, the initialization voltage may be greater than or equal to the second power voltage. For example, the initialization voltage may correspond to a data voltage of the smallest magnitude from among the data voltages, which may be provided. In another example, the magnitude of the initialization voltage may be less than the magnitudes of the data voltages, which may be provided.

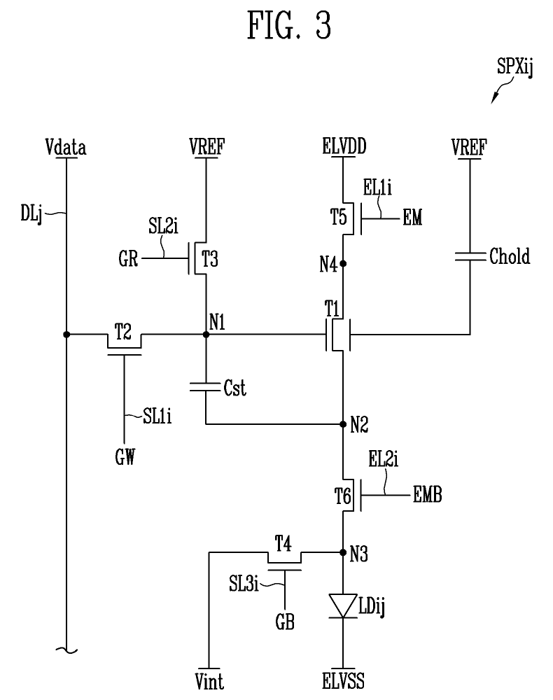

FIG. 3 is a schematic diagram of an equivalent circuit of the sub-pixel SPXij of FIG. 1. The schematic diagram of FIG. 3 is illustrative, and the present disclosure is not limited thereto. The sub-pixels in FIG. 1 may be configured by equivalent circuits having various structures different from that shown in FIG. 3.

Referring to FIG. 3, the sub-pixel SPXij may include first to sixth transistors T1 to T6, a storage capacitor Cst, a hold capacitor Chold, and the light emitting device LDij.

The first transistor T1 (i.e., a driving transistor) includes a first control electrode connected to a first node N1, a first electrode connected to a fourth node N4, a second electrode connected to a second node N2, and a second control electrode connected to the hold capacitor Chold. The second transistor T2 includes a control electrode receiving a first gate signal GW, a first electrode receiving a data voltage Vdata, and a second electrode connected to the first node N1. The third transistor T3 includes a control electrode receiving a second gate signal GR, a first electrode connected to a reference voltage line VREF, and a second electrode connected to the first node N1. The fourth transistor T4 includes a control electrode receiving a third gate signal GB, a first electrode connected to a third node N3, and a second electrode receiving the initialization voltage. The fifth transistor T5 includes a control electrode receiving a first emission control signal EM, a first electrode connected to the first power line ELVDD, and a second electrode connected to the fourth node N4. The sixth transistor T6 includes a control electrode receiving a second emission control signal EMB, a first electrode connected to the second node N2, and a second electrode connected to the third node N3. A first electrode of the storage capacitor Cst may be connected to the first node N1 and a second electrode may be connected to the second node N2. A first electrode of the hold capacitor Chold may be connected to the reference voltage line VREF, and a second electrode may be connected to the second control electrode of the first transistor T1.

Referring to FIG. 3, the data voltage Vdata is provided via the data line DLj, and the first gate signal GW may be provided via a first scan line SL1i. The second gate signal GR may be provided via a second scan line SL2i, and the third gate signal GB may be provided via a third scan line SL3i. The first emission control signal EM may be provided via a first emission control line EL1i, and the second emission control signal EMB may be provided via a second emission control line EL2i. The first to third scan lines SL1i, SL2i, and SL3i may be connected to the scan driver 310 of FIG. 1. In one or more embodiments, the first and second emission control lines EL1i and EL2i may be connected to the scan driver 310 of FIG. 1. In one or more embodiments, the first and second emission control lines EL1i and EL2i may be connected to an emission controller provided separately from the scan driver 310.

In one or more embodiments, the first to sixth transistors T1 to T6 of the sub-pixel SPXij may be N-type transistors. However, this is an example, and the present disclosure is not limited thereto. For example, at least one of the first to sixth transistors T1 to T6 may be a P-type transistor.

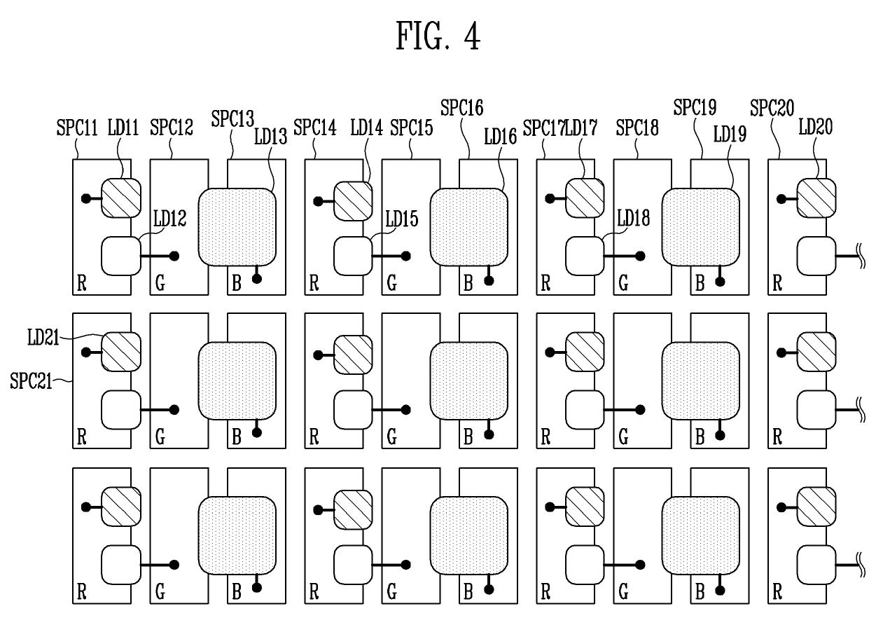

FIG. 4 is a diagram illustrating an embodiment of the pixel portion 330 illustrated in FIG. 1.

Referring to FIG. 4, 30 sub-pixel circuits and 30 light emitting devices are shown. Specifically, the sub-pixel circuits and corresponding light emitting devices are shown in the form of a matrix of 3 rows and 10 columns.

For example, 10 sub-pixel circuits SPC11, SPC12, SPC13, …, and SPC20 are arranged in the first row, which are respectively connected to 10 light emitting devices LD11, LD12, LD13, …, and LD20. Furthermore, 10 sub-pixel circuits SPC21, … are arranged in the second row, which are respectively connected to 10 light emitting devices LD21, …. 10 sub-pixel circuits are arranged in the third row, and 10 light emitting devices are respectively connected thereto. For convenience of description, reference numerals for the sub-pixel circuits after the first sub-pixel circuit SPC21 in the second row and the light emitting devices after the first light emitting device LD21 in the second row are not recited and omitted.

According to the pixel portion shown in FIG. 4, the light emitting devices constituting the sub-pixel are arranged in an RGB stripe structure. However, this is illustrative, and the present disclosure is not limited thereto. For example, the light emitting devices constituting the sub-pixel may be arranged in a PENTILE^{®} structure or other various types of structures.

In FIG. 4, the light emitting devices may be arranged over the sub-pixel circuits, and anode electrodes of the light emitting devices may be connected to the corresponding sub-pixel circuits through contacts.

In FIG. 4, light emitting devices emitting red light are hatched, light emitting devices emitting green light are shown in white, and light emitting devices emitting blue light are shaded. In the present specification, a sub-pixel including a light emitting device that emits red light and a sub-pixel circuit connected thereto is referred to as a red sub-pixel. In addition, in the present specification, a sub-pixel including a light emitting device that emits green light and a sub-pixel circuit connected thereto is referred to as a green sub-pixel. In the present specification, a sub-pixel including a light emitting device that emits blue light and a sub-pixel circuit connected thereto is referred to as a blue sub-pixel.

In the present specification, the sub-pixel circuit connected to the light emitting device that emits red light is referred to as a red sub-pixel circuit, the sub-pixel circuit connected to the light emitting device that emits green light is referred to as a green sub-pixel circuit, and the sub-pixel circuit connected to the light emitting device that emits blue light is referred to as a blue sub-pixel circuit.

For example, among the light emitting devices LD11, LD12, LD13, …, and LD20 connected to the sub-pixel circuits SPC11, SPC12, SPC13, …, and SPC20 located in the first row, the light emitting devices LD11, LD14, LD17, and LD20 emit red light, the light emitting devices LD12, LD15, and LD18 emit green light, and the light emitting devices LD13, LD16, and LD19 emit blue light. The sub-pixel circuits SPC11, SPC14, SPC17, and SPC20 respectively connected to the light emitting devices LD11, LD14, LD17, and LD20 emitting red light are marked with “R”, the sub-pixel circuits SPC12, SPC15, and SPC18 connected to the light emitting devices LD12, LD15, and LD18 emitting green light are marked with “G”, and the sub-pixel circuits SPC13, SPC16, and SPC19 connected to the light emitting devices LD13, LD16, and LD19 emitting blue light are marked with “B”. The same applies to the sub-pixel circuits shown in the second and third rows.

Referring to FIG. 4, the sub-pixel circuits located in each row are arranged in the order to be connected to the light emitting devices displaying colors “R G B R G B R G B R”.

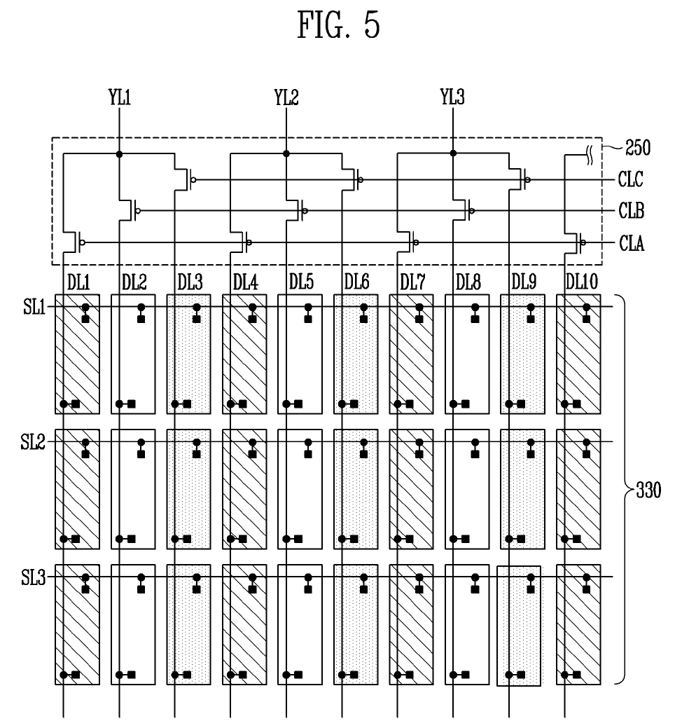

The data lines and the scan lines connected to the sub-pixel circuits shown in FIG. 4 will be described with reference to FIG. 5.

FIG. 5 is a diagram illustrating the data lines and the scan lines connected to the sub-pixel circuits shown in FIG. 4.

Referring to FIG. 5, the 30 sub-pixel circuits shown in FIG. 4 are shown. For ease of discussion, the illustration of the light emitting devices is omitted from FIG. 5. In FIG. 5, the sub-pixel circuits connected to the light emitting devices emitting red light are hatched, the sub-pixel circuits connected to the light emitting devices emitting green light are shown in white, and the sub-pixel circuits connected to the light emitting devices emitting blue light are shaded. As described above, each of the sub-pixel circuits constitutes a sub-pixel, which is included in the pixel portion 330.

The first data line DL1 is connected to the sub-pixel circuits located in the first column and the second data line DL2 is connected to the sub-pixel circuits located in the second column. The third data line DL3 is connected to the sub-pixel circuits located in the third column and the fourth data line DL4 is connected to the sub-pixel circuits located in the fourth column. In the above-described manner, each of the data lines DL1 to DL10 may be connected to the sub-pixel circuits located in the corresponding column.

The scan line SL1 corresponding to the first row is connected to the sub-pixel circuits located in the first row, the scan line SL2 corresponding to the second row is connected to the sub-pixel circuits located in the second row, and the scan line SL3 corresponding to the third row is connected to the sub-pixel circuits located in the third row. In the above-described manner, each of the scan lines SL1 to SL3 may be connected to the sub-pixel circuits located in the corresponding row.

The demultiplexer 250 may be connected to the pixel portion 330 through the data lines. The demultiplexer 250 may selectively output data signals output from the output lines YL1 to YL3 to the data lines DL1 to DL10 based on control signals from control signal lines CLA, CLB, and CLC.

For example, the first control signal line CLA may be activated and the second control signal line CLB and the third control signal line CLC may be deactivated during a first time period. Transistors connected to the first control signal line CLA are turned on and transistors connected to the second control signal line CLB and the third control signal line CLC are turned off. Therefore, the demultiplexer 250 may output the data signals output from the output lines YL1 to YL3 to the data lines DL1, DL4, DL7, and DL10 connected to the red sub-pixel circuits.

During a second period after the first period, the first control signal line CLA and the third control signal line CLC may be deactivated and the second control signal line CLB may be activated. Transistors connected to the first control signal line CLA and the third control signal line CLC are turned off and transistors connected to the second control signal line CLB are turned on. Therefore, the demultiplexer 250 may output the data signals output from the output lines YL1 to YL3 to the data lines DL2, DL5, and DL8 connected to the green sub-pixel circuits.

In addition, during a third period after the second period, the first control signal line CLA and the second control signal line CLB may be deactivated and the third control signal line CLC may be activated. Transistors connected to the first control signal line CLA and the second control signal line CLB are turned off and transistors connected to the third control signal line CLC are turned on. Therefore, the demultiplexer 250 may output the data signals output from the output lines YL1 to YL3 to the data lines DL3, DL6, and DL9 connected to the blue sub-pixel circuits.

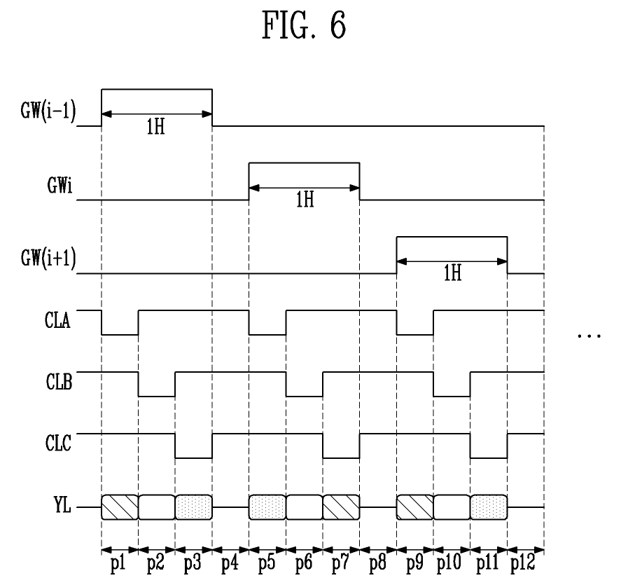

FIG. 6 is a timing diagram illustrating an operation of a display device according to one or more embodiments of the present disclosure.

Referring to FIG. 6, a timing diagram illustrating operations of sub-pixel circuits located in an (i-1)-th row, an i-th row, and an (i+1)-th row during first to 12th periods p1 to p12 is shown.

Specifically, FIG. 6 shows a first gate signal GW(i-1) supplied to the sub-pixel circuits in the (i-1)-th row, a first gate signal GWi supplied to the sub-pixel circuits in the i-th row, and a first gate signal GW(i+1) supplied to the (i+1)-th row. Also shown in FIG. 6 are signals of the first control signal line CLA, the second control signal line CLB, and the third control signal line CLC connected to the demultiplexer 250. Finally, FIG. 6 shows data signals output from an output line YL. The output line YL in FIG. 6 may be one of the output lines YL1 to YL3 shown in FIG. 5. In FIG. 6, a data signal applied to a red sub-pixel circuit is hatched, a data signal to a green sub-pixel circuit is shown in white, and a data signal to a blue sub-pixel circuit is shaded.

Referring to FIG. 6, in the first period p1, the first gate signal GW(i-1) supplied to the sub-pixel circuits in the (i-1)-th row is activated at a high level, and the signal of the first control signal line CLA is activated at a low level. The signal of the second control signal line CLB and the signal of the third control signal line CLC are in a deactivated state (e.g., at a high level). Accordingly, the data voltage Vdata is supplied to red sub-pixel circuits in the (i-1)-th row during the first period p1.

In the second period p2, the first gate signal GW(i-1) supplied to the sub-pixel circuits in the (i-1)-th row remains activated, and the signal of the second control signal line CLB is activated to a low level. The signal of the first control signal line CLA and the signal of the third control signal line CLC are in the deactivated state (e.g., at a high level). Accordingly, the data voltage Vdata is supplied to green sub-pixel circuits in the (i-1)-th row during the second period p2.

In the third period p3, the first gate signal GW(i-1) supplied to the sub-pixel circuits in the (i-1)-th row remains activated, and the signal of the third control signal line CLC is activated to a low level. The signal of the first control signal line CLA and the signal of the second control signal line CLB are in the deactivated state (e.g., at a high level). Accordingly, the data voltage Vdata is supplied to blue sub-pixel circuits in the (i-1)-th row during the third period p3.

The first to third periods p1, p2, and p3 may constitute one horizontal period 1H, and the data voltage Vdata is supplied to the sub-pixel circuits in the (i-1)-th row during the first to third period p1, p2, and p3.

In the fourth period p4, the first gate signal GW(i-1) supplied to the sub-pixel circuits in the (i-1)-th row may be changed to the deactivated state (e.g., at a low level). The signals of the first control signal line CLA, the second control signal line CLB, and the third control signal line CLC may be in the deactivated state (e.g., at a high level) in the fourth period p4.

Then, by a similar process, the data voltage Vdata is supplied to the sub-pixel circuits of the i-th row through the fifth to seventh periods p5, p6, and p7 and the data voltage Vdata may be supplied to the sub-pixel circuits of the (i+1)-th row during the ninth to 11th periods p9, p10, and p11. The signals of the first control signal line CLA, the second control signal line CLB, and the third control signal line CLC may be in the deactivated state (e.g., at a high level) during the eighth period p8 and the 12th period p12.

According to the embodiments shown in FIGS. 4 – 6, the number of output lines YL1 to YLk for outputting data from the data driver 230 is 1/3 of the number of data lines DL1 to DLn connected to the pixel portion 330. That is, the number of lines directly connected to the data driver 230 may be reduced to 1/3 of the number of columns of sub-pixels. However, according to the embodiments shown in FIGS. 4-6, a voltage corresponding to the data signal needs to be transmitted to a gate of a driving transistor of each of the sub-pixel circuits during a period (H/3) corresponding to 1/3 of one horizontal period 1H, which may not be desirable for high-speed driving. In addition, the demultiplexer 250 is present between the data driver 230 and the pixel portion 330, and the number of transistors included in the demultiplexer 350 is the same as the number of data lines DL1 to DLn. That is, because the demultiplexer 250 requiring a large number of transistors is to be included in the display driver 200, the area occupied by the display driver 200 and the power consumed by the display driver 200 are increased.

According to a display device according to one or more embodiments of the present disclosure, sub-pixel circuits corresponding to three columns share each of output lines connected to a data driver without the demultiplexer 250. Accordingly, because the transistors included in the demultiplexer 250 may be removed, the area for fabricating the display driver 200 may be reduced.

In addition, because the sub-pixel circuits are directly connected to the k, which is 1/3 of n, output lines YL1 to YLk, instead of being connected to the n data lines DL1 to DLn, the number of lines arranged in the vertical direction may be reduced.

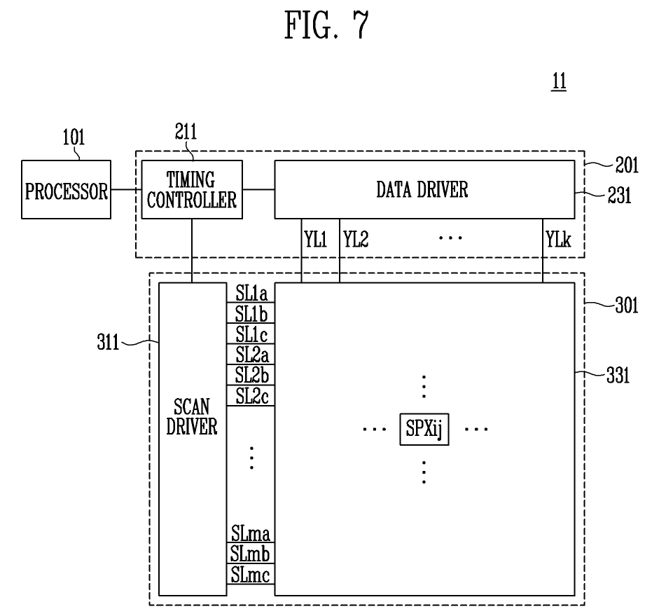

FIG. 7 is a diagram illustrating a display device 11 according to one or more embodiments of the present disclosure.

Referring to FIG. 7, the display device 11 according to one or more embodiments of the present disclosure includes a processor 101, a display driver 201, and a display portion 301. The display driver 201 may include a timing controller 211 and a data driver 231. In addition, the display portion 301 may include a scan driver 311 and a pixel portion 331. Descriptions of the components shown in FIG. 7 which are substantially the same as or partially overlap with those shown in FIG. 1 will be omitted.

The processor 101 and the timing controller 211 of FIG. 7 may be substantially the same as the processor 100 and the timing controller 210 of FIG. 1.

The data driver 231 may generate data voltages (i.e., data signals) output to the output lines YL1, YL2, …, and YLk using gradations and a data control signal received from the timing controller 211. The data signals output to the output lines YL1, YL2, …, and YLk may be multiplexed data signals. The data driver 231 may output the data signals through at least one or more of the output lines YL1, YL2, …, and YLk by using the gradations and the data control signal received from the timing controller 211.

The data driver 231 may be directly connected to the pixel portion 331 of the display portion 301 through the output lines YL1, YL2, …, and YLk. Among sub-pixels of the pixel portion 331, three sub-pixels may be connected to share one output line.

The scan driver 311 may generate scan signals to be provided to first scan lines SL1a, SL2a, …, and SLma, second scan lines SL1b, SL2b, …, and SLmb, and third scan lines SL1c, SL2c, …, and SLmc by using a scan control signal (e.g., a clock signal, a scan start signal, and/or the like) received from the timing controller 211. The scan driver 311 may supply scan signals having a turn-on level pulse to the first scan lines SL1a, SL2a, …, and SLma, the second scan lines SL1b, SL2b, …, and SLmb, and the third scan lines SL1c, SL2c, …, and SLmc.

In one or more embodiments, each of the first scan lines SL1a, SL2a, …, and SLma is connected to red sub-pixel circuits of sub-pixel circuits of a corresponding row, the second scan lines SL1b, SL2b, …, SLmb are connected to green sub-pixel circuits of sub-pixel circuits of a corresponding row, and the third scan lines SL1c, SL2c, …, and SLmc are connected to blue sub-pixel circuits of sub-pixel circuits of a corresponding row. That is, sub-pixels included in one row may be connected to one of a first scan line, a second scan line, and a third scan line corresponding to the row. In the embodiment shown in FIG. 1, the number of scan lines in the row direction is m, whereas in the embodiment shown in FIG. 7, the number of scan lines in the row direction is 3m.

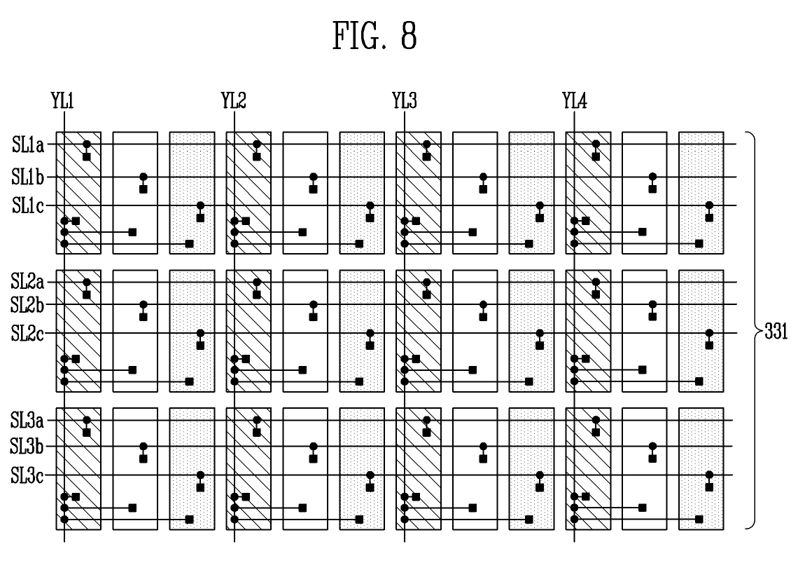

FIG. 8 is a diagram illustrating an embodiment of the pixel portion 331 illustrated in FIG. 7.

Referring to FIG. 8, 36 sub-pixel circuits are shown. For ease of discussion, the illustration of light emitting devices is omitted from FIG. 8. The sub-pixel circuits located in every row are arranged in the order to be connected to light emitting devices displaying colors “R G B R G B R G B R G B”. As described above, each of the sub-pixel circuits constitutes a sub-pixel, which is included in the pixel portion 331.

According to the embodiment shown in FIG. 8, each of the sub-pixel circuits is not connected to a data line, but is directly connected to the output lines YL1 to YL4. The output lines YL1 to YL4 may also be connected to the data driver 231. In particular, each of the output lines YL1 to YL4 may be connected in common to sub-pixels corresponding to three columns.

Specifically, the first output line YL1 is connected to the sub-pixel circuits located in first, second, and third columns, the second output line YL2 is connected to the sub-pixel circuits located in fourth, fifth, and sixth columns, the third output line YL3 is connected to the sub-pixel circuits located in seventh, eighth, and ninth columns, and the fourth output line YL4 is connected to the sub-pixel circuits located in 10th, 11th, and 12th columns. In the above-described manner, each of the output lines YL1 to YL4 may be connected in common to sub-pixel circuits located in corresponding three columns.

The first scan line SL1a corresponding to the first row is connected to red sub-pixel circuits of the sub-pixel circuits located in the first row, and the second scan line SL1b corresponding to the first row is connected to green sub-pixel circuits of the sub-pixel circuits located in the first row. The first scan line SL2a corresponding to the second row is connected to red sub-pixel circuits of the sub-pixel circuits located in the second row, and the second scan line SL2b corresponding to the second row is connected to green sub-pixel circuits of the sub-pixel circuits located in the second row. The first scan line SL3a corresponding to the third row is connected to red sub-pixel circuits of the sub-pixel circuits located in the third row, and the second scan line SL3b corresponding to the third row is connected to green sub-pixel circuits of the sub-pixel circuits located in the third row. In the above-described manner, the first and second scan lines SL1a to SL3a and SL1b to SL3b may be selectively connected to odd-numbered sub-pixel circuits or even-numbered sub-pixel circuits from among the sub-pixel circuits located in the corresponding row. Also, the third scan line SL1c corresponding to the first row is connected to blue sub-pixel circuits of the sub-pixel circuits located in the first row, the third scan line SL2c corresponding to the second row is connected to blue sub-pixel circuits of the sub-pixel circuits located in the second row, and the third scan line SL3c corresponding to the third row is connected to blue sub-pixel circuits of the sub-pixel circuits located in the third row. In the above-described manner, the third scan lines SL1c to SL3c may be selectively connected to odd-numbered sub-pixel circuits or even-numbered sub-pixel circuits from among the sub-pixel circuits located in the corresponding row.

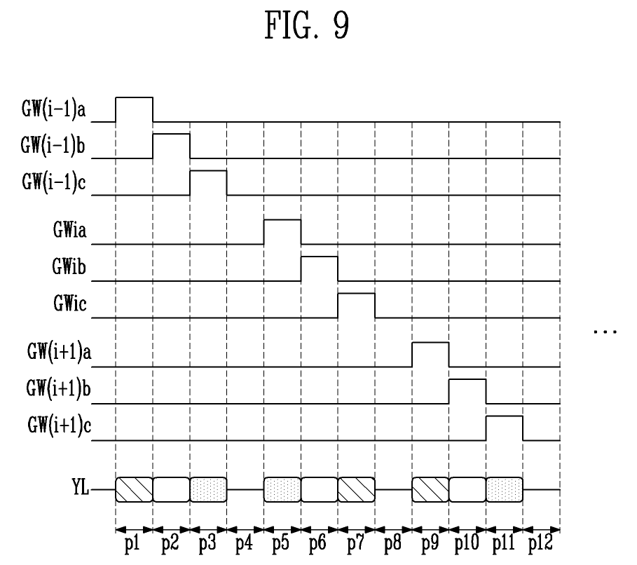

FIG. 9 is a timing diagram illustrating an operation of the display device 11 according to the embodiment of FIG. 8.

Referring to FIG. 9, a timing diagram illustrating operations of the sub-pixel circuits located in the (i-1)-th row, the i-th row, and the (i+1)-th row during the first to 12th periods p1 to p12 is shown.

Specifically, FIG. 9 illustrates first to third gate signals GW(i-1)a, GW(i-1)b, and GW(i-1)c supplied to the sub-pixel circuits in the (i-1)-th row, first to third gate signals GWia, GWib, and GWic supplied to the sub-pixel circuits in the i-th row, and first to third gate signals GW(i+1)a, GW(i+1)b, GW(i+1)c supplied to the sub-pixel circuits in the (i+1)-th row. Also shown in FIG. 9 are data signals output from the output line YL. The output line YL in FIG. 9 may be one of the output lines YL1 to YL4 shown in FIG. 8. In FIG. 9, a data signal applied to a red sub-pixel circuit is hatched, a data signal to a green sub-pixel circuit is shown in white, and a data signal to a blue sub-pixel circuit is shaded.

Referring to FIG. 9, in the first period p1, the first gate signal GW(i-1)a from among the first to third gate signals GW(i-1)a, GW(i-1)b, and GW(i-1)c supplied to the sub-pixel circuits of the (i-1)-th row is activated at a high level, and the second and third gate signals GW(i-1)b and GW(i-1)c remain in a deactivated state (e.g., at a low level). In addition, in the first period p1, the first to third gate signals GWia, GWib, and GWic supplied to the sub-pixel circuits in the i-th row and the first to third gate signals GW(i+1)a, GW(i+1)b, and GW(i+1)c supplied to the sub-pixel circuits in the (i+1)-th row also remain in the deactivated state (e.g., at a low level). Accordingly, the data voltage Vdata is supplied to the red sub-pixel circuits in the (i-1)-th row during the first period p1.

In the second period p2, the second gate signal GW(i-1)b from among the first to third gate signals GW(i-1)a, GW(i-1)b, and GW(i-1)c supplied to the sub-pixel circuits in the (i-1)-th row is activated at a high level, and the first and third gate signals GW(i-1)a and GW(i-1)c remain in the deactivated state (e.g., at a low level). In addition, in the second period p2, the first to third gate signals GWia, GWib, and GWic supplied to the sub-pixel circuits in the i-th row and the first to third gate signals GW(i+1)a, GW(i+1)b, and GW(i+1)c supplied to the sub-pixel circuits in the (i+1)-th row also remain in the deactivated state (e.g., at a low level). Accordingly, the data voltage Vdata is supplied to the green sub-pixel circuits in the (i-1)-th row during the second period p2.

In the third period p3, the third gate signal GW(i-1)c from among the first to third gate signals GW(i-1)a, GW(i-1)b, and GW(i-1)c supplied to the sub-pixel circuits in the (i-1)-th row is activated at a high level, and the first and second gate signals GW(i-1)a and GW(i-1)b remain in the deactivated state (e.g., at a low level). In addition, in the third period p3, the first to third gate signals GWia, GWib, and GWic supplied to the sub-pixel circuits in the i-th row and the first to third gate signals GW(i+1)a, GW(i+1)b, and GW(i+1)c supplied to the sub-pixel circuits in the (i+1)-th row also remain in the deactivated state (e.g., at a low level). Accordingly, the data voltage Vdata is supplied to the blue sub-pixel circuits in the (i-1)-th row during the third period p3.

The first to third periods p1,p2, and p3 may constitute one horizontal period 1H, and the data voltage Vdata is supplied to the sub-pixel circuits in the (i-1)-th row during the first to third periods p1, p2, and p3.

In the fourth period p4, the first to third gate signals GW(i-1)a, GW(i-1)b, and GW(i-1)c supplied to the sub-pixel circuits in the (i-1)-th row may remain in the deactivated state (e.g., at a low level). In addition, in the fourth period p4, the first to third gate signals GWia, GWib, and GWic supplied to the sub-pixel circuits in the i-th row, and the first to third gate signals GW(i+1)a, GW(i+1)b, and GW(i+1)c supplied to the sub-pixel circuits in the (i+1)-th row may remain in the deactivated state (e.g., at a low level).

Then, by a similar process, the data voltage Vdata is supplied to the sub-pixel circuits of the i-th row during the fifth to seventh periods p5, p6, and p7 and the data voltage Vdata may be supplied to the (i+1)-th row sub-pixel circuit during the ninth to 11th periods p9, p10, and p11. The first to third gate signals GWia, GWib, and GWic supplied to the sub-pixel circuits in the i-th row, and the first to third gate signals GW(i+1)a, GW(i+1)b, and GW(i+1)c supplied to the sub-pixel circuits in the (i+1)-th row may be in the deactivated state in the eighth period p8 and the 12th period p12.

According to the embodiments shown in FIGS. 7-9, sub-pixel circuits corresponding to three columns share each of output lines connected to a data driver without the demultiplexer 250. Accordingly, because transistors included in the demultiplexer 250 may be removed, the area for fabricating the display driver 200 may be reduced.

In addition, because the sub-pixel circuits are directly connected to the k, which is 1/3 of n, output lines YL1 to YLk, instead of being connected to the n data lines DL1 to DLn, the number of lines arranged in the vertical direction may be reduced.

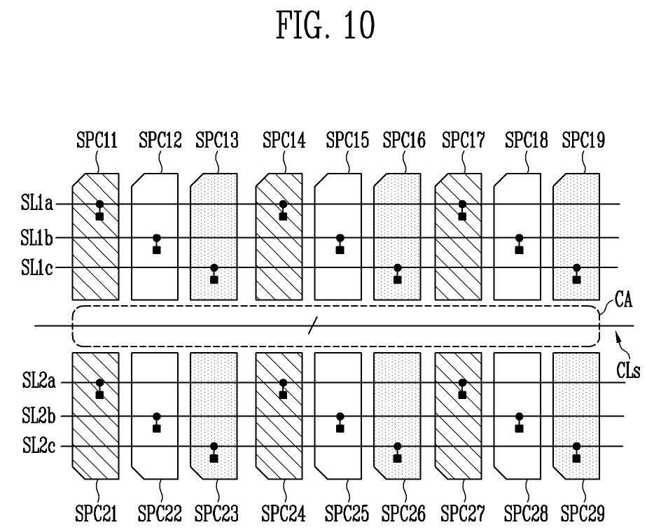

FIG. 10 is a diagram illustrating another embodiment of the pixel portion 331 illustrated in FIG. 7.

Referring to FIG. 10, 18 sub-pixel circuits are shown. For ease of discussion, the illustration of output lines is omitted from FIG. 10. As described above, each of the sub-pixel circuits constitutes a sub-pixel, which is included in the pixel portion 331.

In FIG. 10, three sub-pixels included in one pixel are arranged in the row direction. Specifically, in FIG. 10, the sub-pixel circuits SPC11, SPC12, and SPC13 constitute one pixel. The sub-pixel circuits SPC11, SPC12, SPC13 are arranged in the row direction, which is a direction in which the scan lines extend.

A shared area CA may be arranged between pixels in the first row and pixels in the second row. Common lines CLs may be arranged in the shared area CA. The common lines CLs may be connected in common to sub-pixel circuits included in each of the pixels in the first row and sub-pixel circuits included in each of the pixels in the second row.

As an example, the common lines CLs may include at least one of the reference voltage line VREF, the second scan line SL2i, the third scan line SL3i, the first emission control line EL1i, or the second emission control line EL2i shown in FIG. 3. In one or more embodiments, the common lines CLs may include a repair line for repairing a defective pixel.

Similarly, the shared area CA may be arranged between pixels in the third row and pixels in the fourth row.

According to one or more embodiments of the present disclosure, the sub-pixel circuits formed on opposite sides in the column direction with respect to the shared area CA may have symmetrical layouts. For example, a layout of a circuit forming the red sub-pixel circuit SPC11 located in the first column and the first row and a layout of a circuit forming the red sub-pixel circuit SPC21 located in the first column and the second row may have linearly symmetrical shapes with respect to the shared area CA. Similarly, a layout of a circuit forming the green sub-pixel circuit SPC12 located in the second column and the first row and a layout of a circuit forming the green sub-pixel circuit SPC22 located in the second column and the second row may have linearly symmetrical shapes with respect to the shared area CA. Accordingly, the sub-pixel circuits located on opposite sides in the column direction with respect to the shared area CA may have the same electrical characteristics.

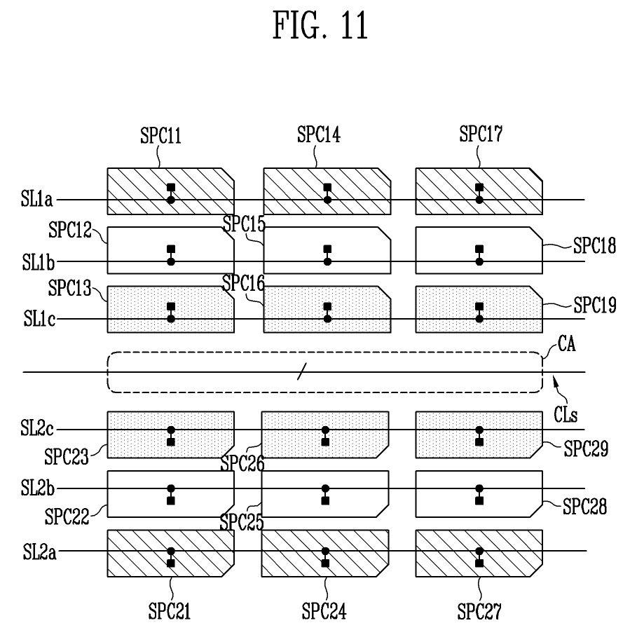

FIG. 11 is a diagram illustrating another embodiment of the pixel portion 331 illustrated in FIG. 7.

Referring to FIG. 11, 18 sub-pixel circuits are shown. For ease of discussion, the illustration of output lines is omitted from FIG. 11. As described above, each of the sub-pixel circuits constitutes a sub-pixel, which is included in the pixel portion 331.

Unlike the arrangement shown in FIG. 10, in FIG. 11, three sub-pixels belonging to one pixel are arranged in the column direction. Specifically, in FIG. 11, the sub-pixel circuits SPC11, SPC12, and SPC13 constitute one pixel. The sub-pixel circuits SPC11, SPC12, SPC13 are arranged in the column direction, which is a direction in which the output lines extend.

Similarly to FIG. 10, in FIG. 11, the shared area CA may be arranged between pixels in the first row and pixels in the second row. The common lines CLs may be arranged in the shared area CA. The common lines CLs may be connected in common to sub-pixel circuits included in each of the pixels in the first row and sub-pixel circuits included in each of the pixels in the second row.

Similarly, in one or more embodiments, the shared area CA may be arranged between pixels in the third row and pixels in the fourth row.

According to one or more embodiments of the present disclosure, the sub-pixel circuits formed on opposite sides in the column direction with respect to the shared area CA may have symmetrical layouts. For example, the blue sub-pixel circuits SPC13, SPC16, SPC19, SPC23, SPC26, and SPC29 may be located nearest to the shared area CA, the green sub-pixel circuits SPC12, SPC15, SPC18, SPC22, SPC25, and SPC28 may be located farther from the shared area CA than the blue sub-pixel circuits, and the red sub-pixel circuits SPC11, SPC14, SPC17, SPC21, SPC24, and SPC27 may be located farthest from the shared area CA.

In addition, a layout of a circuit forming the red sub-pixel circuit SPC11 and a layout of a circuit forming the red sub-pixel circuit SPC21 may have linearly symmetrical shapes with respect to the shared area CA. Likewise, a layout of a circuit forming the green sub-pixel circuit SPC12 and a layout of a circuit forming the green sub-pixel circuit SPC22 may have linearly symmetrical shapes with respect to the shared area CA. Accordingly, the sub-pixel circuits located on opposite sides in the column direction with respect to the shared area CA may have the same electrical characteristics.

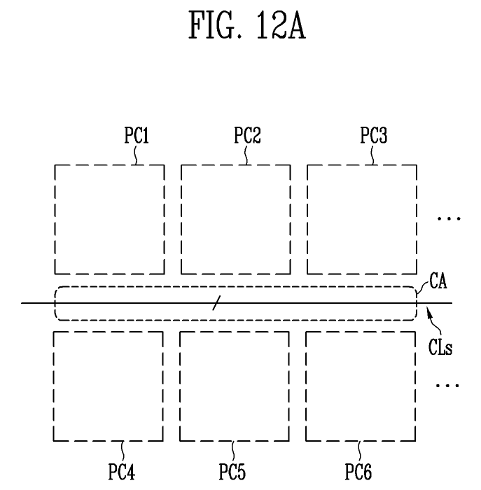

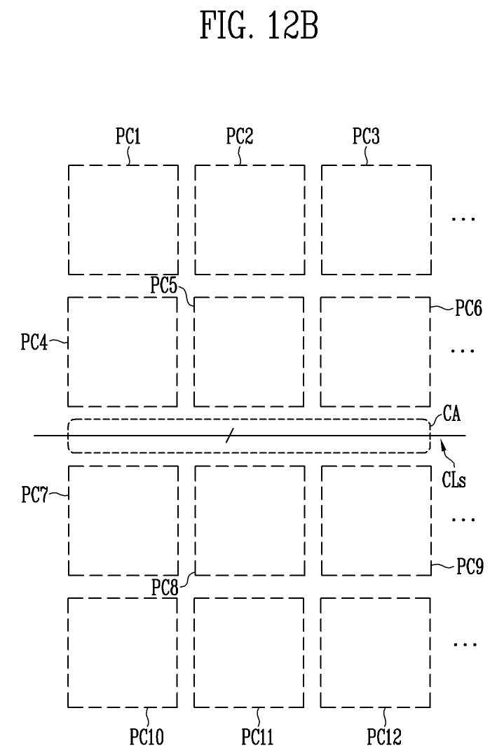

FIGS. 12A and 12B are diagrams illustrating embodiments of pixels sharing common lines arranged in the shared area CA.

Referring to FIG. 12A, six pixels PC1, PC2, PC3, PC4, PC5, and PC6 are shown. As described with reference to FIGS. 10 and 11, one pixel may include a plurality of sub-pixels. For example, the pixel PC1 may include the sub-pixel circuits SPC11, SPC12, and SPC13, the pixel PC2 may include the sub-pixel circuits SPC14, SPC15, and SPC16, and the pixel PC3 may include the sub-pixel circuits SPC17, SPC18, and SPC19. The pixel PC4 may include the sub-pixel circuits SPC21, SPC22, and SPC23, the pixel PC5 may include the sub-pixel circuits SPC24, SPC25, and SPC26, and the pixel PC6 may include sub-pixel circuits SPC27, SPC28, and SPC29.

FIG. 12A shows an embodiment in which the pixels PC1, PC2, PC3, PC4, PC5, and PC6 corresponding to two rows share the shared area CA. However, the present disclosure is not limited thereto.

Referring to FIG. 12B, an embodiment is shown in which the pixels PC1 to PC12 corresponding to four rows share the shared area CA. As the number of pixel rows sharing the shared area CA increases, the area occupied by the shared area CA in the entire pixel portion decreases. Accordingly, the resolution of the pixel portion may be increased.

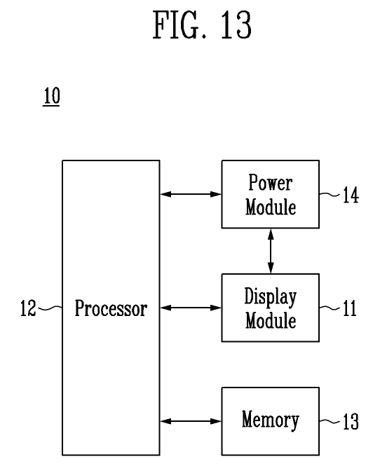

FIG. 13 is a block diagram of an electronic device 10 according to one or more embodiments. Referring to FIG. 13, the electronic device 10 according to one or more embodiments may include a display module 11, a processor 12, memory 13, and a power module 14.

The processor 12 may include at least one of a central processing unit (CPU), an application processor (AP), a graphics processing unit (GPU), a communication processor (CP), an image signal processor (ISP), or a controller.

The memory 13 may store data information necessary for an operation of the processor 12 or the display module 11. When the processor 12 executes an application stored in the memory 13, an image data signal and/or an input control signal is transmitted to the display module 11, and the display module 11 may process the received signal and output image information through a display screen.

The power module 14 may include a power supply module such as a power adapter or a battery device, and a power conversion module that converts power supplied by the power supply module to generate power necessary for an operation of the electronic device 10.

At least one of the above-described components of the electronic device 10 may be included in the display device according to the above-described embodiments. In addition, one or more of the individual modules which are functionally included in one module may be included in the display device, and individual modules other than the one or more individual modules may be provided separately from the display device. For example, the display device includes the display module 11, and the processor 12, the memory 13, and the power module 14 may be provided in the form of other devices in the electronic device 10 other than the display device.

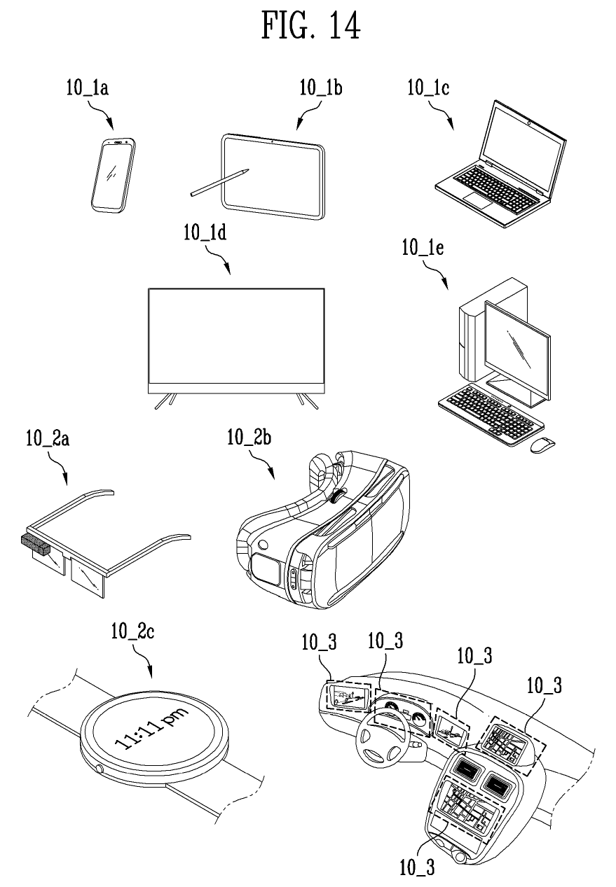

FIG. 14 shows schematic diagrams of electronic devices according to various embodiments.

Referring to FIG. 14, various electronic devices to which the display device according to one or more embodiments is applied may include electronic devices for displaying an image such as a smartphone 10_1a, a tablet PC 10_1b, a laptop 10_1c, a television 10_1d, or a desk monitor 10_1e, as well as wearable electronic devices including display modules such as smart glasses 10_2a, a head-mounted display 10_2b, or a smart watch 10_2c, and automotive electronic devices 10_3 including display modules such as an automotive dashboard, a center fascia, a Center Information Display (CID) placed on a dashboard, and/or a room mirror display.

The foregoing referenced drawings and detailed descriptions of the present disclosure are mere examples of the present disclosure and are intended to illustrate the present disclosure but are not intended to limit the meaning or to restrict the scope of the present disclosure as claimed in the appended claims. Accordingly, those skilled in the art will understand that various modifications and other equivalent embodiments can be made from the foregoing referenced drawings and detailed descriptions. The true scope of technical protection of the present disclosure should therefore be determined by the technical spirit of the appended claims and their equivalents.

A display device and an electronic device having the same according to one or more embodiments of the present disclosure, power consumption required for an operation of a data driver and heat generation may be reduced, and the number of transistors included in a display driver may be reduced.

What is claimed is:

1. A display device, comprising:
a plurality of sub-pixel circuits arranged in a matrix form having a plurality of rows and a plurality of columns;
a plurality of light emitting devices, each of the plurality of light emitting devices being connected to a corresponding sub-pixel circuit from among the plurality of sub-pixel circuits;
a data driver configured to output a data signal to the plurality of sub-pixel circuits through a plurality of output lines; and
a scan driver configured to output a scan signal to the plurality of sub-pixel circuits through a plurality of first scan lines, a plurality of second scan lines, and a plurality of third scan lines,
wherein each of the plurality of output lines is connected in common to three sub-pixel circuits included in one pixel from among the plurality of sub-pixel circuits,
wherein each of the plurality of first scan lines is connected to first color sub-pixel circuits in a corresponding row from among the plurality of sub-pixel circuits,
wherein each of the plurality of second scan lines is connected to second color sub-pixel circuits in a corresponding row from among the plurality of sub-pixel circuits, and
wherein each of the plurality of third scan lines is connected to third color sub-pixel circuits in a corresponding row from among the plurality of sub-pixel circuits.

2. The display device according to claim 1, wherein the plurality of sub-pixel circuits are arranged in a matrix form having m rows and n columns,
wherein a number of the first scan lines is m, a number of the second scan lines is m, and a number of the output lines is n/3,
wherein during a horizontal period corresponding to a selected row from among the plurality of rows, the scan driver activates:
a voltage of a first scan line corresponding to the selected row from among the plurality of first scan lines during a first period of the horizontal period;
a voltage of a second scan line corresponding to the selected row from among the plurality of second scan lines during a second period of the horizontal period different from the first period; and
a voltage of a third scan line corresponding to the selected row from among the plurality of third scan lines during a third period of the horizontal period different from the first period and the second period, and
wherein m and n each are an integer of 2 or more.

3. The display device according to claim 2, wherein during the first period, data output to the plurality of output lines is applied to the first color sub-pixel circuits from among sub-pixel circuits corresponding to the selected row,
wherein during the second period, the data output to the plurality of output lines is applied to the second color sub-pixel circuits from among the sub-pixel circuits corresponding to the selected row, and
wherein during the third period, the data output to the plurality of output lines is applied to the third color sub-pixel circuits from among the sub-pixel circuits corresponding to the selected row.

4. The display device according to claim 1, wherein the plurality of light emitting devices are located above or below the plurality of sub-pixel circuits.

5. The display device according to claim 1, wherein the three sub-pixel circuits are arranged in a row direction in the one pixel.

6. The display device according to claim 5, wherein a shared area is located between sub-pixels in a first row and sub-pixels in a second row, and
wherein at least one common line, which is connected in common to the sub-pixels in the first row and the sub-pixels in the second row, is in the shared area.

7. The display device according to claim 6, wherein a circuit layout of each of the sub-pixels in the first row and a circuit layout of each of the sub-pixels in the second row have linearly symmetrical shapes with respect to the shared area.

8. The display device according to claim 6, wherein the common line comprises a repair line for repairing a defective pixel.

9. The display device according to claim 1, wherein the three sub-pixel circuits are arranged in a column direction in the one pixel,
wherein a shared area is located between sub-pixels in first to third rows and sub-pixels in fourth to sixth rows, and
wherein at least one common line, which is connected in common to the sub-pixels in the first to third rows and the sub-pixels in the fourth to sixth rows, is in the shared area.

10. The display device according to claim 9, wherein, the third color sub-pixel circuits are in the third and fourth rows nearest to the shared area in the one pixel,
wherein the second color sub-pixel circuits are in the second and fifth rows adjacent to the third color sub-pixel circuits, and
wherein the first color sub-pixel circuits are in the first and sixth rows farthest from the shared area in the one pixel.

11. The display device according to claim 10, wherein a circuit layout of each of the sub-pixels in the first row and a circuit layout of each of the sub-pixels in the sixth row have linearly symmetrical shapes with respect to the shared area,
wherein a circuit layout of each of the sub-pixels in the second row and a circuit layout of each of the sub-pixels in the fifth row have linearly symmetrical shapes with respect to the shared area, and
wherein a circuit layout of each of the sub-pixels in the third row and a circuit layout of each of the sub-pixels in the fourth row have linearly symmetrical shapes with respect to the shared area.

12. The display device according to claim 1, wherein the data driver is configured to output data to k output lines,
wherein the scan driver is configured to output a scan signal to m first scan lines, m second scan lines, and m third scan lines,
wherein the plurality of sub-pixel circuits are arranged in a matrix form having m rows and 3k columns,
wherein an h-th output line from among the output lines is connected in common to sub-pixel circuits located in a (3h-2)-th column, a (3h-1)-th column, and a 3h-th column from among the plurality of sub-pixel circuits,
wherein an i-th first scan line among the first scan lines is connected to (3j-2)-th sub-pixel circuits from among the sub-pixel circuits located in an i-th row,
wherein an i-th second scan line from among the second scan lines is connected to (3j-1)-th sub-pixel circuits from among the sub-pixel circuits located in the i-th row,
wherein an i-th third scan line from among the third scan lines is connected to 3j-th sub-pixel circuits from among the sub-pixel circuits located in the i-th row,
wherein m and n each are an integer of 2 or more, k is an integer of 1 or more, h is an integer greater than 0 and less than or equal to k, i is an integer greater than 0 and less than or equal to m, and j is an integer greater than 0 and less than or equal to k.

13. The display device according to claim 12, wherein during a horizontal period corresponding to the i-th row, the scan driver activates:
a voltage of the i-th first scan line during a first period of the horizontal period;
a voltage of the i-th second scan line during a second period of the horizontal period different from the first period; and
a voltage of the i-th third scan line during a third period of the horizontal period different from the first period and the second period.

14. The display device according to claim 13, wherein a shared area is located between sub-pixels in a (2i-1)-th row and sub-pixels in a 2i-th row, and
wherein at least one common line, which is connected in common to the sub-pixels in the (2i-1)-th row and the sub-pixels in the 2i-th row, is arranged in the shared area.

15. A display device, comprising:
a data driver configured to output data to k output lines;
a scan driver configured to output a scan signal to m first scan lines, m second scan lines, and m third scan lines; and
a pixel portion connected to the output lines, the first scan lines, the second scan lines, and the third scan lines,
wherein the pixel portion comprises:
a plurality of sub-pixel circuits arranged in a matrix form having 3m rows and k columns; and
a plurality of light emitting devices, each of the plurality of light emitting devices being connected to a corresponding sub-pixel circuit from among the plurality of sub-pixel circuits,
wherein an h-th output line from among the output lines is connected in common to sub-pixel circuits located in an h-th column from among the plurality of sub-pixel circuits,
wherein an i-th first scan line from among the first scan lines is connected to sub-pixel circuits in a (3i-2)-th row,
wherein an i-th second scan line from among the second scan lines is connected to sub-pixel circuits in a (3i-1)-th row,
wherein an i-th third scan line from among the third scan lines is connected to sub-pixel circuits in a 3i-th row,
wherein m and n each are an integer of 2 or more, k is an integer of 1 or more, h is an integer greater than 0 and less than or equal to k, and i is an integer greater than 0 and less than or equal to m.

16. The display device according to claim 15, wherein the sub-pixel circuits in the (3i-2)-th row are first color sub-pixel circuits, the sub-pixel circuits in the (3i-1)-th row are second color sub-pixel circuits, and the sub-pixel circuits in the 3i-th row are third color sub-pixel circuits.

17. The display device according to claim 16, wherein a shared area is located between sub-pixels in the 3i-th row and sub-pixels in a (3i+1)-th row, and
wherein at least one common line, which is connected in common to the sub-pixel circuits in the (3i-2)-th row, the sub-pixel circuits in the (3i-1)-th row, the sub-pixel circuits in the 3i-th row, sub-pixel circuits in the (3i+1)-th row, sub-pixel circuits in a (3i+2)-th row, and sub-pixel circuits in a (3i+3)-th row, is located in the shared area.

18. The display device according to claim 17, wherein the sub-pixel circuits in the (3i+1)-th row are the third color sub-pixel circuits, the sub-pixel circuits in the (3i+2)-th row are the second color sub-pixel circuits, and the sub-pixel circuits in the (3i+3)-th row are the first color sub-pixel circuits.

19. The display device according to claim 18, wherein a circuit layout of each of the sub-pixel circuits in the (3i+1)-th row and a circuit layout of each of the sub-pixel circuits in the 3i-th row have linearly symmetrical shapes with respect to the shared area,
wherein a circuit layout of each of the sub-pixel circuits in the (3i+2)-th row and a circuit layout of each of the sub-pixel circuits in the (3i-1)-th row have linearly symmetrical shapes with respect to the shared area, and
wherein a circuit layout of each of the sub-pixel circuits in the (3i+3)-th row and a circuit layout of each of the sub-pixel circuits in the (3i-2)-th row have linearly symmetrical shapes with respect to the shared area.

20. An electronic device, comprising:
a processor configured to provide input image data; and
a display device configured to display an image based on the input image data, wherein the display device comprises:
a plurality of sub-pixel circuits arranged in a matrix form having a plurality of rows and a plurality of columns;
a plurality of light emitting devices, each of the plurality of light emitting devices being connected to a corresponding sub-pixel circuit from among the plurality of sub-pixel circuits;
a data driver configured to output a data signal to the plurality of sub-pixel circuits through a plurality of output lines; and
a scan driver configured to output a scan signal to the plurality of sub-pixel circuits through a plurality of first scan lines, a plurality of second scan lines, and a plurality of third scan lines,
wherein each of the plurality of output lines is connected in common to three sub-pixel circuits included in one pixel from among the plurality of sub-pixel circuits,
wherein each of the plurality of first scan lines is connected to first color sub-pixel circuits in a corresponding row from among the plurality of sub-pixel circuits,
wherein each of the plurality of second scan lines is connected to second color sub-pixel circuits in a corresponding row from among the plurality of sub-pixel circuits, and
wherein each of the plurality of third scan lines is connected to third color sub-pixel circuits in a corresponding row from among the plurality of sub-pixel circuits.
